(19) United States
(12) Patent Application Publication
(10) Pub. No.: US 2002/0126617 A1
(43) Pub. Date: Sep. 12, 2002

(54) Method and apparatus to encode information in, and dispose a human-readable pattern on, a rotatable data storage medium

(75) Inventors: Robert George Emberty, Tucson, AZ (US); Craig Anthony Klein, Tucson, AZ (US)

Correspondence Address: Dale F. Regelman, Hayes, Soloway, Hennessey,, Grossman & Hage, P.C., 130 W. Cushing Street, Tucson, AZ, 85701, US

(73) Assignee: International Business Machines Corporation

(21) Appl. No.: 09/799,842

(22) Filed: Mar. 6, 2001

(51) Int. Cl. G11B 3/70; G11B 5/84; G11B 7/26; G11B 7/24

(52) U.S. Cl. 369/272; 369/275.2

(57) ABSTRACT

A method to store first information in a rotatable data storage medium and to dispose second information on a rotatable data storage medium. An apparatus comprising a constant linear velocity drive servo, a laser device, and a computer useable medium having computer readable program code disposed therein for sequencing laser irradiations to encode first information in a rotatable data storage medium and to dispose second information on a rotatable data storage medium. A rotatable disk storage medium having first information encoded in the information area and at least one human-readable pattern disposed on the clamp area and/or the information area.

### FIELD OF THE INVENTION

The present invention is generally directed to an information storage method and apparatus wherein that apparatus and method allow the same recording device to both write information to a rotatable data storage medium, and to also dispose a human-readable pattern on that rotatable data storage medium.

### BACKGROUND OF THE INVENTION

The commercial craving for increased information storage density on recordable media has been a significant driving force in present day information-handling systems technology development. Commercial and market forces have driven the demand for an increase in the raw amount of data needed to be stored and accessed upon a removable device. These forces have also increased the demand that this information be available quickly and accurately. In addition, there has been an increase in the desire to make the information on these disks writable by end users.

In that regard, optical storage media, and more particularly, the optical disk, is currently finding increasing use in the high density storage of large quantities of data. In the optical medium, the information is retrieved through the interaction of a radiation beam with the information storage medium. At present, three principal types of optical storage media are in common use.

The first type of optical storage medium is manufactured with the information stored thereon, generally in the form depressions formed into a polycarbonate substrate. A reflecting coating is deposited on the polycarbonate substrate and the radiation beam is focused on the reflecting layer. This type of optical disk is frequently referred to as a ROM (i.e., read only memory) disk. Because a ROM disk is not an end user writable disk, Applicants' method and apparatus are not used in conjunction with such a ROM disk.

The second type of optical storage medium has the capability of having information recorded (written) thereon at some time after the fabrication of the medium. Such an optical storage medium in the disk embodiment is frequently referred to as a writable optical storage disk. In general, information can only be written one time to such a writable disk. Such disks are sometimes call “write once” disks. Applicant's apparatus and method can be used to both write data to the information portion of such a writable disk, and to dispose a human-readable pattern such as a label on the non-information portion of that disk.

The third type of optical storage medium also has the capacity to have information recorded on the medium after fabrication. In addition, at a later time, the stored information can be erased or modified. This type of optical storage medium in the disk embodiment is generally referred to as an erasable or a re-writable optical storage disk. Applicant's apparatus and method can be used to both write data to the information portion of such a re-writable disk, and to dispose a human-readable pattern such as a label on the non-information portion of that disk.

In each type of optical storage (disk) medium, the storage layer is supported and protected by a polycarbonate support substrate and by a protective (lacquer) overcoat layer. However, the storage layer is modified in the writable disk and in the re-writable disk. The storage layer in the writable disk includes a reflector layer (generally fabricated from gold) proximate the lacquer overcoat layer and includes a recording layer, typically a dye polymer layer, proximate the polycarbonate layer. The newly fabricated re-writable optical storage disk has a recording layer that is responsive to radiation having selected parameters, the radiation changing the optical properties of the recording layer.

With either the writable and re-writable disks, differences in the optical properties of the recording layer can be detected, through the interaction with an impinging radiation beam and data, encoded by means of the optical property changes, can be recovered. The recording, storage, and/or the reflective layer of the writable/re-writable optical disks are many times called the storage layer. In the optical information storage and retrieval system, a read/write head is moved in a specified path relative to the optical storage medium. The read/write head provides a radiation beam which, after interacting with a region of the optical storage medium, is detected. The information stored on the optical storage medium takes the form of data-bearing regions with differing optical properties depending, for example on the logical state being represented by the particular region. The radiation beam which has interacted with the optical storage medium has detectable differences resulting from the interaction with the information-bearing regions. These detectable differences are converted into electrical signals. The electrical signals are subsequently converted to a format which can be conveniently manipulated by a signal processing system.

In each of the disk embodiments described above, the information stored on the disk may be considered to lie in a series of tracks spaced radially from a center hub, sometimes called the clamp area. The information track typically begins in a pre-user data area near the center hub. A user-data area follows the pre-user data area, and contains the information imparted to the disc. A lead-out area follows the user-data area, lying closer to the outer edge of the disc. The lead-out area generally contains no user data. The pre-user data area, user-data area, and lead-out area collectively comprise the “information area” of the disc.

As the spiral information track progress from the center area to the outer edge area, the radius of that track gradually increases. Thus, the information content is encoded in the information area in a slightly arcuate, circumferential pattern.

### SUMMARY OF THE INVENTION

Applicants' invention includes an apparatus to encode first information in, and dispose second information on, a rotatable data storage medium. Such first information may comprise, for example, data stored in the information area of an optical disk. Such second information may comprise, for example, one or more human-readable patterns disposed on the clamp area of an optical disk and/or disposed in the information area of that disk.

Applicants' apparatus includes a rotatable data storage disk recording apparatus having a constant linear velocity (“CLV”) drive servo. A rotatable data storage disk which includes a clamp area and a information area is placed in Applicants' apparatus, and that apparatus encodes both first information and second information within, for example, the information area of the disk.

Applicants' invention further includes a method to encode first information in, and dispose second information on, a rotatable data storage medium, using a recording apparatus having a CLV drive servo. Applicant's method involves scaling the timing vectors used by such a CLV apparatus to, for example, radially dispose a human-readable pattern on either the information area and/or the clamp area of an optical disk.

Applicants' invention further comprises a rotatable disk storage medium having a clamp area and an information area, where that rotatable medium has first information encoded in the information area and one or more human-readable patterns disposed on the information area and/or the clamp area. In certain embodiments, Applicants' rotatable disk storage medium comprises an optical disk.

### BRIEF DESCRIPTION OF THE DRAWINGS

The invention will be better understood from a reading of the following detailed description taken in conjunction with the drawings in which like reference designators are used to designate like elements, and in which:

FIG. 1 is a top view showing the portions of a typical rotatable data storage medium;

FIG. 2 shows a human-readable, radially-oriented, rectangular pattern disposed on a rotatable data storage medium;

FIG. 3 shows an offset pattern formed using a fixed timing scenario with a recording apparatus having a CLV disk servo;

FIG. 4 shows the initial radius and incremental radii for the various portions of the offset pattern of FIG. 3;

FIG. 5 shows a human-readable, radially-oriented, rectangular pattern formed using Applicants' method in conjunction with a recording apparatus having a CLV disk servo; and

FIG. 6 graphically depicts a fixed timing sequence used by prior art CLV recording devices.

### DETAILED DESCRIPTION OF THE PREFERRED EMBODIMENTS

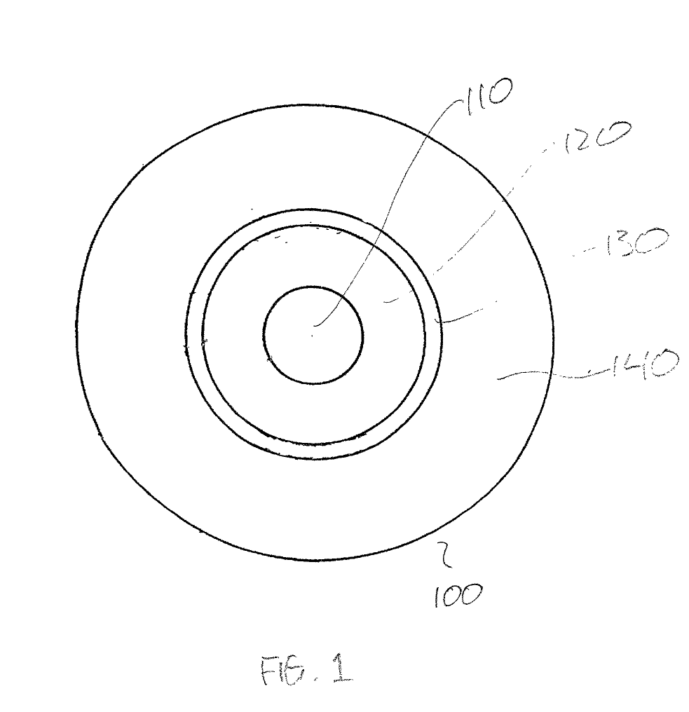

Turning to FIG. 1, optical data storage disk 100 comprises four regions which, with increasing radius can be defined as the following. Aperture 110 provides a structure to engage a spindle for controlled rotation of disk 100. The next area is clamp area 120.

Clamp area 120 typically does not have a data storage layer associated therewith. Rather, clamp area 120 is used to provide a space wherein the spindle can be mechanically coupled to the disk without interfering with access to the data stored on the disk.

Mirror area 130 has a data storage layer associated therewith but typically does not have information embedded therein. Therefore, mirror area 130 typically has a mirror-like appearance. Information area 140 includes a data information storage layer associated therewith, and therefore, has data stored therein. Consequently, because of the structure comprising data embedded within the data storage layer, information area 140 typically has a dull appearance when compared to the mirror-like appearance of mirror area 130.

Applicants' invention includes an apparatus and a method for writing data on information area 140 by using a recording device, such as a laser, and for using that same device to dispose one or more human readable patterns comprising text and/or graphics, such as a label, on the information area 140, the clamp area 120, or both. Recording data on the information area of such a writable/re-writable disk occurs when a laser light amount per unit area irradiated exceeds a predetermined value. Disposing a human-readable pattern on the clamp area occurs when, for example, sufficient laser energy is directed to specific portions of the surface of the molded plastic disk to carbonize those surface portions. Disposing a human-readable pattern on the information area occurs when the laser device irradiates portions of the information area thereby altering the optical properties of those irradiated portions such that the irradiated portions reflect light in the visible spectrum differently than do the non-irradiated areas of the information area.

Disk drive systems for recording and/or reproducing data on and/or from such a rotatable data storage disk utilize either a constant angular velocity (“CAV”) drive servo or a constant linear velocity (“CLV”) drive servo. Using a CAV drive system, data is recorded and/or reproduced on and/or from the disk such that the rotation rate of the disk is kept constant. On the other hand when using a CLV drive system, data is recorded and/or reproduced data on and/or from the disk such that the linear velocity of the disk is kept constant.

When recording on a disk with a diameter of 20 cm using the CAV drive mode, the rotation rate of the disk is constant at about 900 revolutions/minute (r.p.m.). In contrast, in the CLV drive mode the linear velocity is kept constant, and therefore, the disk is rotated at about 900 r.p.m. at its inner periphery. As the optical recording device or head is moved toward the outer periphery of the disk, however, the revolution number of the disk is lowered and the disk is rotated at about 525 r.p.m. in its outer periphery.

Optical disk media, including writable and re-writable disks, is generally written and read at a constant linear velocity. Thus, optical disk recording devices generally use a CLV drive servo. This differs from the typical hard-disk drive media and high-density floppy-disk drive media, which are written to, and are read from, using a constant angular velocity.

In order to dispose a human-readable pattern on a disk using a recording apparatus having a CAV servo, the laser pulses are simply timed from a revolution index mark. As discussed above, however, optical disk recording drives exclusively utilize a CLV servo mechanism. Moreover, these drives typically do not have a CAV servo.

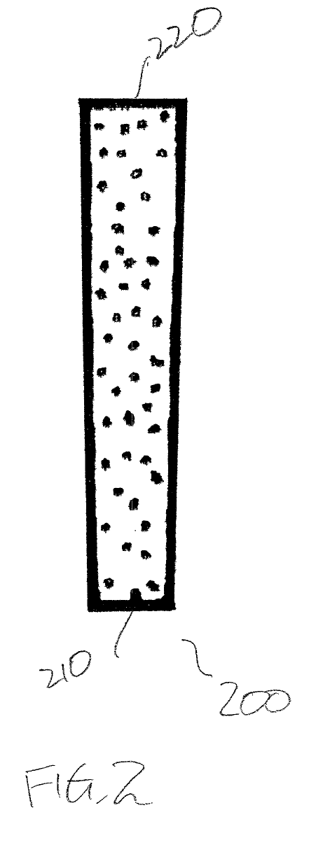

Therefore, when using a recording apparatus having only a CLV drive servo, the fixed timing scheme used with a CAV drive servo must be modified. Disposing a radially-oriented, human readable pattern onto a rotatable data storage medium necessarily means that a change in the radius will occur with respect to the initial portions of the pattern in relation to the final portion of the pattern. Referring to FIG. 2, pattern 200 is radially disposed on the clamp area of an optical disk, with first edge 210 disposed nearest the aperture and second edge 220 disposed farthest from the aperture. The radius from the center of the aperture to first edge 210 is necessarily shorter than the radius from the center of the aperture to second edge 220.

Because of the change in radius while radially disposing pattern 200 onto a rotating disk, a CLV drive servo alters the speed of the disk while disposing that pattern in order to maintain a constant media velocity under the laser head. Therefore, the timing scheme used for disposing a pattern, such as a label, onto a rotating disk using a CAV servo drive must be adjusted, or scaled, to account for the change in speed of the media. This scaling factor is directly related to the change of radius encountered while writing such a large pattern to the media.

Referring again to FIG. 2, rectangular graphic 200 is approximately 2 mm high. Referring to Equation (1), it is axiomatic that the circumference of circle equals twice the radius times pi.

C=(2)(π)(R) (1)

where C is circumference and R is the radius. Thus, the change in the circumference upon a change in the radius is shown in Equation 2.

ΔC=(2)(π)Δ(R) (2)

Therefore, if there is a ΔR during the writing of a pattern, such as a label, on a medium rotated using a CLV drive, there will be a corresponding ΔC offset of the pattern.

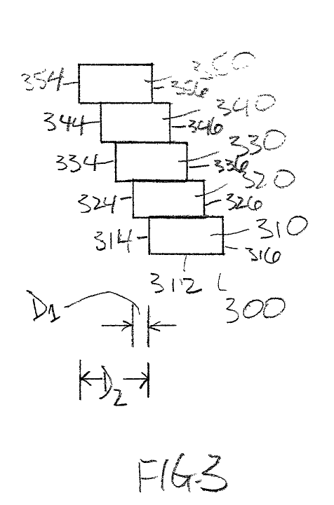

Referring to FIG. 3, graphic 300 was disposed on a rotating disk using a recording apparatus having a CLV drive and a timing pattern wherein the recording laser device is turned on and then off at fixed intervals. Graphic 300 was formed during five (5) rotations, and comprises initial portion 310, first incremental portion 320, second incremental portion 330, third incremental portion 340, and fourth incremental portion 350.

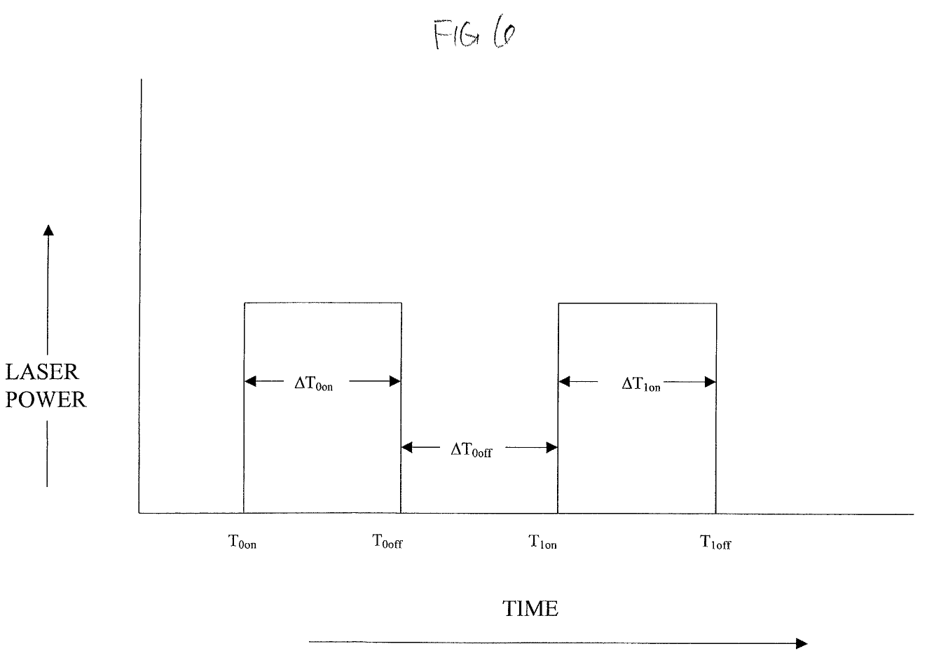

In using a CLV drive servo and fixed timing intervals, initial portion 310 is formed by initiating irradiation of the surface of the disk at time T₀ₒₙ to form first edge 314. The surface irradiation continues until time T_{0off}. The cessation of irradiation forms second edge 316. Therefore, in order to form initial portion 310 the laser recording device was operated for a time period ΔT₀ₒₙ corresponding to T_{0off}−T₀ₒₙ. FIG. 6 graphically depicts the time segments wherein the recording device is “on” and wherein the recording device is “off.” After forming initial portion 310, no further surface irradiation occurs until the disk completes almost a complete rotation. As shown in FIG. 6, no irradiation takes place during the period of time corresponding to ΔT_{0off}.

Subsequently, first incremental portion 320 is formed by again irradiating the disk surface, beginning at time T₁ₒₙ, and continuing that irradiation for time ΔT₁, where ΔT₀=ΔT₁. No irradiation then occurs for a period of time corresponding to ΔT_{1off}. Second incremental portion 330 is formed once again beginning irradiation at time T₂ₒₙ, and continuing that irradiation for time ΔT₂, where ΔT₀=ΔT₁=ΔT₂. In this fixed timing scenario, the periods when no irradiation occurs, namely ΔT_{0off} and ΔT_{1off}, are equal.

Referring again to FIG. 3, first incremental portion 320 is offset from initial portion 310 by distance D₁. The distance D₁ corresponds to the ΔC offset discussed above. Again referring to FIG. 3, each subsequent incremental portion is offset from the previous portion. Distance D₂ represents the aggregate offset error resulting from using a fixed timing scheme and a CLV servo mechanism when radially disposing a human readable pattern, such as a label, on a rotatable disk. When writing a label having a radial height of 2 mm, the offset error would be as great as (2)(π)(2 mm), or greater than 12 mm in the tangential direction. This offset error is not a function of the original radius of the pattern, but is solely a function of the change of radius encountered as the total pattern is written.

Thus, if a fixed timing scheme is used for CLV recording, there will always be a slewing of the pattern. For recording over a partial revolution of Θ radians, the error is given by equation (3).

ΔARC=(Θ)(ΔR) (3)

Thus, a fixed timing scheme cannot be used with a recording device having a CLV servo to radially dispose a human readable pattern, such as a label, on a rotatable disk, such as an writable/re-writable optical disk. Therefore, Applicants' method uses Equation (4) to scale the timings for sequential irradiations to form incremental portions of a human-readable pattern based upon the ratio of the incremental radius to the initial radius.

Incremental Timing Vector=(Initial Timing Vector)(R_{incremental}/Rᵢₙᵢₜᵢₐₗ) (4)

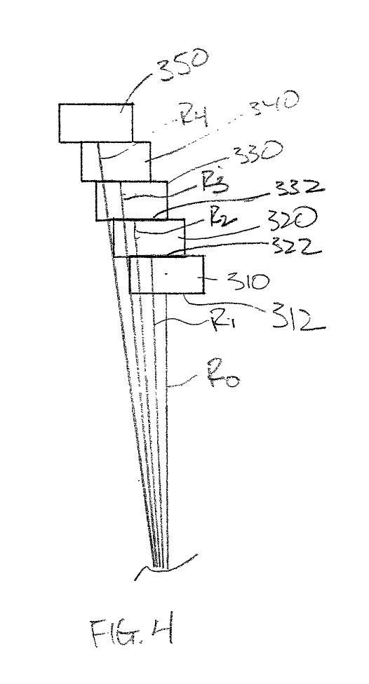

By initial timing vector, Applicants mean, with respect to forming first incremental portion 320, the time of commencing the initial irradiation T₀ₒₙ, the initial irradiation time period ΔT₀ₒₙ, and the initial period between irradiations ΔT_{0off}. By incremental timing vector, Applicants mean in this example, the time of commencing the first incremental irradiation T₁ₒₙ, the first incremental irradiation time period ΔT₁, and the first incremental time period between irradiations ΔT_{1off}. Referring to FIG. 4, by Rᵢₙᵢₜᵢₐₗ Applicants mean, in this example, the distance R₀ from the center of aperture 110 (FIG. 1) to bottom edge 312 of initial portion 310. By R_{incremental} Applicants mean distance R1 from the center of aperture 110 (FIG. 1) to bottom edge 322 of first incremental portion 320.

When disposing second incremental portion 330, the initial timing vector means time T₁ₒₙ, time period ΔT₁ₒₙ, and time period ΔT_{1off}, and the incremental timing vector means time T₂ₒₙ, ΔT₂ₒₙ, and ΔT_{2off}. Similarly in conjunction with disposing second incremental portion 330, Rᵢₙᵢₜᵢₐₗ means the distance R₁ from the center of aperture 110 (FIG. 1) to bottom edge 322 of first incremental portion 320, and R_{incremental} means distance R2 from the center of aperture 110 (FIG. 1) to bottom edge 332 of second incremental portion 330.

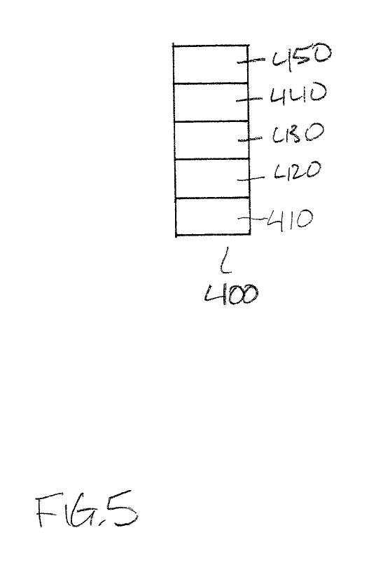

In a similar fashion, radii R3 and R4 are used to scale the timing vectors to form third incremental portion 340 and fourth incremental portion 350, respectively. When properly scaling each incremental timing vector, the recording apparatus using a CLV drive servo disposes on a rotatable disk the pattern shown in FIG. 5.

Graphic 400 is formed from initial portion 410, first incremental portion 420, second incremental portion 430, third incremental portion 440, and fourth incremental portion 450. By scaling the timing vectors used to form these individual portions, each incremental portion is properly aligned with the portion below it and also with the portion above it.

Applicants' recording apparatus includes a constant linear velocity drive servo, a laser recording device, and a computer useable medium having computer readable program code disposed therein for sequencing laser irradiations to encode first information in a rotatable data storage medium and to dispose second information on a rotatable data storage medium. Specifically, the computer readable program code comprises a series of computer readable program steps to first determine an initial timing vector required to dispose an initial portion of a human-readable pattern on the rotatable data storage medium, where that initial portion of said human-readable pattern is disposed at an initial radius Rᵢₙᵢₜᵢₐₗ. Referring to FIG. 4, Rᵢₙᵢₜᵢₐₗ comprises, for example, radius R0 which represents the distance from the center of the hub to side 213 of initial portion 310.

The computer readable program code disposed in Applicants' apparatus further includes a series of computer readable program steps to determine an incremental timing vector to dispose an incremental portion of the human-readable pattern on rotatable data storage medium, where that incremental portion of said human-readable pattern is disposed at an incremental radius R_{incremental}. Referring again to FIG. 4, R_{incremental} comprises, for example, R1 which represents the distance from the center of the hub to side 322 of first incremental portion 320. The computer readable program code disposed in Applicants' apparatus further includes a series of computer readable program steps to determine the incremental timing vector using the equation:

incremental timing vector=(initial timing vector)(R_{incremental}/Rᵢₙᵢₜᵢₐₗ)

where the initial timing vector comprises the time of commencing the initial irradiation, the initial irradiation time period, and the initial time period between irradiations, and where the incremental timing vector comprises the time of commencing the incremental irradiation, the incremental irradiation time period, and the incremental time period between irradiations.

While the invention has been described in detail herein in accordance with certain preferred embodiments thereof, many modifications and changes therein my be effected by those skilled in the art. Accordingly, it is intended by the appended claims to cover all such modifications and changes as fall within the true spirit and scope of the invention.

What is claimed is:

1. A method to store first information in, and to dispose second information on, a rotatable data storage medium, comprising the steps of:
providing a rotatable data storage medium recording apparatus;
providing a rotatable data storage medium, wherein said a rotatable data storage disk comprises a clamp area and an information area;
placing said rotatable data storage medium into said recording apparatus;
encoding said first information in said information area; and
disposing said second information on said rotatable data storage medium.

2. The method of claim 1, wherein said wherein said recording apparatus comprises a laser device.

3. The method of claim 2, wherein said second information comprises a human-readable pattern.

4. The method of claim 3, wherein said human-readable pattern is disposed on said information area.

5. The method of claim 3, wherein said human-readable pattern is disposed on said clamp area.

6. The method of claim 3, wherein said rotatable data storage medium comprises an optical disk.

7. The method of claim 6, wherein said optical disk comprises a writable optical storage disk.

8. The method of claim 6, wherein said optical disk comprises a re-writable optical storage disk.

9. The method of claim 1, wherein said disposing step further comprises using a constant angular velocity drive servo.

10. The method of claim 1, wherein said disposing step further comprises using a constant linear velocity drive servo.

11. The method of claim 10, further comprising the steps of:
determining an initial timing vector required to dispose an initial portion of said pattern, wherein said initial portion of said pattern is disposed at an initial radius Rᵢₙᵢₜᵢₐₗ; and
determining an incremental timing vector to dispose an incremental portion of said pattern, wherein said incremental portion of said pattern is disposed at an incremental radius R_{incremental}.

12. The method of claim 11, wherein said incremental timing vector is determined using the equation:
incremental timing vector=(initial timing vector)(R_{incremental}/Rᵢₙᵢₜᵢₐₗ).

13. The method of claim 12, wherein said initial timing vector comprises the time of commencing the initial irradiation, the initial irradiation time period, and the initial period between irradiations.

14. The method of claim 13, wherein said incremental timing vector comprises the time of commencing the incremental irradiation, the incremental irradiation time period, and the incremental period between irradiations.

15. A rotatable data storage medium recording apparatus to encode information in a rotatable data storage medium and to dispose a human-readable pattern on said rotatable data storage medium, wherein said rotatable data storage medium recording apparatus comprises a laser device, a constant linear velocity drive servo, and a computer useable medium having computer readable program code disposed therein for sequencing irradiations from said laser device onto said rotatable data storage medium, the computer readable program code comprising a series of computer readable program steps to effect:
determining an initial timing vector required to dispose an initial portion of said human-readable pattern on said rotatable data storage medium, wherein said initial portion of said human-readable pattern is disposed at an initial radius Rᵢₙᵢₜᵢₐₗ; and
determining an incremental timing vector to dispose an incremental portion of said human-readable pattern on rotatable data storage medium, wherein said incremental portion of said human-readable pattern is disposed at an incremental radius R_{incremental}.

16. The rotatable data storage medium recording apparatus of claim 15, wherein said rotatable data storage medium comprises an optical disk.

17. The rotatable data storage medium recording apparatus of claim 16, wherein said optical disk comprises a writable optical storage disk.

18. The rotatable data storage medium recording apparatus of claim 16, wherein said optical disk comprises a re-writable optical storage disk.

19. The rotatable data storage medium recording apparatus of claim 13, wherein said computer readable program code further comprises a series of computer readable program steps to determine said incremental timing vector using the equation:
incremental timing vector=(initial timing vector)(R_{incremental}/Rᵢₙᵢₜᵢₐₗ).

20. The rotatable data storage medium recording apparatus of claim 19, wherein said initial timing vector comprises the time of commencing the initial irradiation, the initial irradiation time period, and the initial time period between irradiations.

21. The rotatable data storage medium recording apparatus of claim 20, wherein said incremental timing vector comprises the time of commencing the incremental irradiation, the incremental irradiation time period, and the incremental time period between irradiations.

22. A rotatable disk storage medium comprising a clamp area and an information area wherein first information is encoded in same information area, and wherein a first human-readable pattern is disposed on said information area.

23. The rotatable disk storage medium of claim 22, wherein a second human-readable pattern is disposed on said clamp area.

24. The rotatable disk storage medium of claim 22, wherein said first human-readable pattern is disposed on said clamp area.

25. The rotatable disk storage medium of claim 22, wherein said rotatable data storage medium comprises an optical disk.

26. The rotatable disk storage medium of claim 25, wherein said optical disk comprises a writable optical storage disk.

27. The rotatable disk storage medium of claim 25, wherein said optical disk comprises a re-writable optical storage disk.
